(19) United States
(12) Patent Application Publication
(10) Pub. No.: US 2016/0223725 A1
(43) Pub. Date: Aug. 4, 2016

(54) Light Diffusing Film, Method for Manufacturing Same, and Backlight Unit Using Same for Liquid Crystal Display

(71) Applicant: KOREA INSTITUTE OF INDUSTRIAL TECHNOLOGY, Chungcheongnam-do (KR)

(72) Inventors: Dae Young Lim, Yongin-si (KR); Won Young Jeong, Gunpo-si (KR); Tae Hyung Kim, Ansan-si (KR)

(73) Assignee: Korea Institute of Industrial Technology, Cheonan-si (KR)

(21) Appl. No.: 14/903,352

(22) PCT Filed: May 30, 2014
(86) PCT No.: PCT/KR2014/004848

§ 371 Date: Jan. 7, 2016

(30) Foreign Application Priority Data
Jul. 10, 2013 (KR) 10-2013-0081209

(51) Int. Cl. G02B 5/02; B29C 70/20; G02F 1/1335; B29C 47/10; G02B 5/30; G02B 1/08; B29D 11/00; B29C 47/00

(52) U.S. Cl. CPC G02B 5/0236; B29D 11/00798; B29C 70/202; B29C 47/0021; B29C 47/1045; G02B 5/0268; G02B 5/3083; G02B 1/08; G02F 1/133606; B29C 43/24

(57) ABSTRACT

The present invention relates to a diffusion sheet, a method for manufacturing the same, and a backlight unit using the same for a liquid crystal display. The diffusion sheet of the present invention is configured to have at least two or more fibrous layers alternately embedded within a matrix, and arranged at the combination of at least two or more angles of 0°, 90° and ±θ between successive layers, each fibrous layer having fibers arranged in parallel to each other in one direction, so that the diffusion sheet promotes two-dimensional diffusion distributions, thus uniformly diffusing the light irrespective of the initial angle and direction, to a method for manufacturing a diffusion sheet wherein a matrix component and a fibrous layer component are simultaneously extruded to allow fibrous layers to be arranged in situ in a matrix, the present invention has the benefit of simultaneously shortening the process and thinning the thickness. Furthermore, by using the diffusion sheet according to the present invention, a liquid crystal display backlight unit having high opacity and improved light diffusion property can be provided.

### CROSS REFERENCE TO RELATED APPLICATIONS

This application is a 371 National State application of International Application No. PCT/KR2014/004848 filed on May 30, 2014, which claims priority of Korean Serial Number 10-2013-0081209 filed on Jul. 10, 2013, both of which are incorporated herein by reference in their entireties.

### BACKGROUND OF THE INVENTION

1. Field of the Invention

The present invention relates to a diffusion sheet, a method for manufacturing a diffusion sheet, and a backlight unit using the same for a liquid crystal display, and more particularly, to a diffusion sheet that is configured to have at least two or more fibrous layers alternately embedded within a matrix, so that the diffusion sheet promotes two-dimensional diffusion distributions, thus uniformly diffusing the light irrespective of the initial angle and direction, to a method for manufacturing a diffusion sheet wherein a matrix component and a fibrous layer component are simultaneously extruded to allow fibrous layers to be arranged in situ in a matrix. Thus the method can reduce the number of processes and achieving the thinning of thickness. Furthermore, the present invention relates to a backlight unit for a liquid crystal display equipped with the diffusion sheet.

2. Description of the Prior Art

liquid crystal displays (LCDs) are nonemissive innature. So, an LCD requires an independent light source called a backlight unit (BLU), which supplies the LCD with bright, homogeneous, and white light.

The BLU is a key component of LCDs because the color gamut, contrast ratio, and picture quality of LCDs depend mainly on the BLU. Thus, improvements in LCD performance require advancements in BLU quality.

The BLU comprises a number of components such as light sources, optical films, driving circuits, and mold frames, to name a few. In recent years, extensive efforts have been made to develop new optical films and to fabricate devices that can perform several optical functions. For example, in light plate guides (LPGs), an array of microprisms performs the functions of several optical films. In collimating films, a micropyramid film replaces two crossed prism films.

Particularly, a diffusion sheet is also an important component of the BLU, because it diffuses from the light source uniformly and thus increases the uniformity of luminosity substantially.

In the fields of the film for the backlight unit of the liquid crystal display, accordingly, many studies and developments have been made on the diffusion sheet having excellent opacity and light diffusion so that the light emitted from a light source lamp can be transmitted to a diffusing plate or a light guide plate, without any loss, thus uniformly diffusing the light.

In conventional practice, diffusion sheets are disclosed (in Japanese Patent Nos. 7-174909, 2000-27862 and 1998-20430), wherein transparent organic or inorganic particles as a light diffuser are applied to a transparent plastic film and a transparent resin binder is then coated on the film, thus forming a light diffusing layer. According to the conventional diffusion sheets, however, light is transmitted directly to each film, without any refraction or scattering, due to the section of the light diffusing layer formed by using the transparent organic or inorganic particles having constant mean sizes, thus unpreferably decreasing the luminance of the backlight unit.

Accordingly, the opacity and luminance properties of the conventional bead type diffusion sheets having the organic or inorganic particles are dependent upon the kinds, sizes, refractive index control and distribution of light diffuser used therein.

So as to allow the intensity of light from a light source to be uniformly distributed and to improve the brightness of the screen, other examples of the diffusion sheets are disclosed (in Japanese Patent Application Laid-open No. 11-509014), wherein anisotropic particles are arranged at specific intervals in an isotropic material, and disclosed (in Japanese Patent Application Laid-open No. 2003-302507), wherein a plurality of birefringent fibers is arranged in parallel to each other.

According to the conventional diffusion sheets, however, the fibers spun are arranged in the isotropic material and attached to the isotropic material by means of pressing.

FIG. 4 is a photograph showing the section of a conventional diffusion sheet. According to the conventional diffusion sheet, the bundles of fibers on the fibrous layer in the film are stick to each other, so that loss of light is increased due to the rear scattering occurring on the rear side thereof with respect to the advancing direction of light, thus making the display darkened. Accordingly, there is a need for the development of a diffusion sheet capable of efficiently diffusing the light forwardly.

According to another conventional diffusion sheet obtained by means of laminates on which a textile-reinforced material is impregnated, if the textile-reinforced material having fiber bundles located in warp thread direction and fiber bundles located in weft thread direction is impregnated in a matrix resin and then hardened, matrix resin rich areas occur between the surface of the fiber bundles located in the warp thread direction and the surface of the fiber bundles located in the weft thread direction, thus making the thickness between the laminates unpreferably increased.

So as to increase the strength between the layers in the fiber-oriented composite material, accordingly, there are provided methods for stitching reinforcement fibers in a thickness direction of the laminates or for making a three-dimensionally shaped fiber preform and impregnating a resin in the preform. However, the conventional methods require high-priced equipment for precise fiber arrangements, which is not achieved with the existing equipment. Through the conventional methods, further, it is difficult to obtain high density in the fibers arranged in a thickness direction.

Therefore, the present inventors have made various studies to solve the above problems and as a result, they have found a diffusion sheet wherein a matrix component and a fibrous layer component are at the same time extruded to allow fibrous layers to be arranged in situ in a matrix, thus reducing the number of processes and achieving the thinning of thickness, and more particularly, they have found that a diffusion sheet having at least two or more fibrous layers alternately stacked in a matrix, each fibrous layer having fibers arranged in parallel to each other in one direction, so that the diffusion sheet promotes two-dimensional diffusion distributions, thus uniformly diffusing the light irrespective of the initial angle and direction, and a backlight unit for a liquid crystal display with the diffusion sheet having excellent opacity and light diffusion.

### BRIEF SUMMARY OF THE INVENTION

Accordingly, the present invention has been made in view of the above-mentioned problems occurring in the prior art, and it is an object of the present invention to provide a diffusion sheet comprising at least two or more fibrous layers are embedded within a polymer matrix, which each fibrous layer is arranged in parallel to each other in one direction.

It is another object of the present invention to provide a method for manufacturing a diffusion sheet wherein fibrous layers are simultaneously extruded into the polymer matrix in-situ manner.

It is other object of the present invention to provide a backlight unit for a liquid crystal display equipped with a diffusion sheet.

To accomplish the above-mentioned objects, according to a first aspect of the present invention, there is provided a diffusion sheet configured to have at least two or more fibrous layers alternately embedded within a matrix and arranged at the combination of at least two or more angles of 0°, 90° and ±θ between successive layers, each fibrous layer having nano-sized fibers is arranged in parallel to each other in one direction.

According to the present invention, the polymer matrix is made of an optically isotropic or optically anisotropic polymer resin.

According to the present invention, preferably, when the nano-sized fibers of each fibrous layer are arranged in one direction, the fibers are adjacent in parallel to each other at given constant intervals.

According to the present invention, the nano-sized fibers are birefringent organic fibers, the refractive index of the birefringent organic fibers is 0.05% greater than the refractive index of the polymer resin of the matrix, and under the refractive indexes, light transmittance is greater than 40%.

According to the present invention, preferably, the sectional shapes of the birefringent organic fibers are selected from the group consisting of a circle, a triangle, a square, or a different shaped section having a combination thereof.

According to the present invention, preferably, the birefringent organic fibers are one or more selected from the group consisting of polyethylene naphthalate (PEN), polycyclohexane dimethylterephthalate (PCT), co-polyethylene naphthalate (co-PEN), polyethylene therephthalate (PET), polycarbonate (PC), polycarbonate alloy, polystyrene (PS), heat-resistant polystyrene (PS), polymethyl methacrylate (PMMA), polybutylene terephthalate (PBT), polypropylene(PP), polyethylene(PE), acrylonitrile butadiene styrene (ABS), polyurethane (PU), polyimide (PI), polyvinyl chloride (PVC), styrene acrylonitrile copolymer (SAN), ethylene-vinyl acetate (EVA), polyamide (PA), polyoxymethylene(POM), phenol, epoxy(EP), urea-formaldehyde (UF), Melamine-formaldehyde (MF), unsaturated polyester (UP), silicone (SI), elastomer, and cyclo-olefin polymer (COP).

According to the present invention, preferably, when the birefringent organic fibers are polycyclohexane dimethylterephthalate (PCT) and the transparent polymer resin is poly-4-methylene pentene (PMP), the birefringent organic fibers and the transparent polymer resin are contained at the weight ratio of 3:7 to 5:5, so that the optical properties like haze and transmittance are improved and further tensile strength is increased to achieve the improvement in the brittleness of the diffusion sheet.

To accomplish the above-mentioned objects, according to a second aspect of the present invention, there is provided a method for manufacturing a diffusion sheet, the method including the steps of: feeding birefringent organic fiber component and a transparent component into a bi-component spinneret, extruding simultaneously the birefringent organic fibers in one direction into a polymer matrix made of a transparent polymer resin and being alternately stacked 90° and ±θ with respect to each other between successive layers of the polymer to form at least two or more fibrous layers in-situ manner, and elongating and cooling the fibrous layers arranged in the matrix.

To accomplish the above-mentioned objects, according to a third aspect of the present invention, there is provided a method for manufacturing a diffusion sheet, the method including the steps of: feeding birefringent organic fiber component and a transparent component into a bi-component spinneret, extruding simultaneously the birefringent organic fibers in one direction into a polymer matrix made of a transparent polymer resin and being alternately stacked 90° and ±θ with respect to each other between successive layers of the polymer to form at least two or more fibrous layers in-situ manner, and binding alternately the fibrous layers stacked with each other.

According to the present invention, preferably, the birefringent organic fibers and the transparent polymer resin are extruded simultaneously at the weight ratio of 3:7 to 7:3.

According to the present invention, the binding is any one selected from the group consisting of double belt press, lamination, or calendaring.

To accomplish the above-mentioned objects, according to a fourth aspect of the present invention, there is provided a backlight unit for a liquid crystal display equipped with the diffusion sheet.

According to the present invention, there is provided the alternately piled-up structure of the diffusion sheet comprising nano-sized fibers are embedded within a polymer matrix and each fibrous layer having nano-sized fibers is arranged in parallel to each other in one direction, so that the diffusion sheet promotes two-dimensional diffusion distributions, irrespective of the initial angle and direction, thus allowing the conventional bead type diffusion sheets to be replaced thereby.

Further, there is provided the method for manufacturing the diffusion sheet wherein nano-sized fibers are embedded within a polymer matrix and the nano-sized fibers are arranged in parallel to each other in one direction in-situ manner and also, there is provided the backlight unit for a liquid crystal display equipped with the diffusion sheet having excellent opacity and light diffusion.

### BRIEF DESCRIPTION OF THE DRAWINGS

FIG. 1 is schematic structure showing a diffusion sheet according to a first embodiment of the present invention.

FIG. 2 is schematic structure showing a diffusion sheet according to a second embodiment of the present invention.

FIG. 3 is a photograph showing the section of the diffusion sheet according to the present invention.

FIG. 4 is a photograph showing the section of a conventional diffusion sheet.

FIG. 5 is an image showing the surface of organic fibers constituting the diffusion sheet according to the present invention.

FIG. 6 is an image showing the surfaces of the films through a scanning electron microscope according to the mixing ratios of the organic fibers and transparent polymer resin constituting the diffusion sheet according to the present invention.

FIG. 7 is an image showing optical properties of the diffusion sheets of FIG. 6.

FIG. 8 is diffusion image showing the scattering patterns of the diffusion sheet according to the present invention.

FIG. 9 is graph showing angular distributions of the luminance with respect to the angle along the horizontal angle of 0°, oblique angle of 45°, and vertical angle of 90° directions (a) without the diffusion sheet and (b) with the diffusion sheet according to the present invention.

### DETAILED DESCRIPTION OF THE PREFERRED EMBODIMENTS

Hereinafter, the present invention will be in detail described with reference to drawings.

The present invention provides an alternately piled-up structure of the diffusion sheet (1) that the diffusion sheet is configured to have at least two or more fibrous layers alternately are embedded within a matrix (20) and are arranged at the combination of at least two or more angles of 0°, 90° and ±θ between successive layers, each fibrous layer (10) having nano-sized fibers is arranged in parallel to each other in one direction.

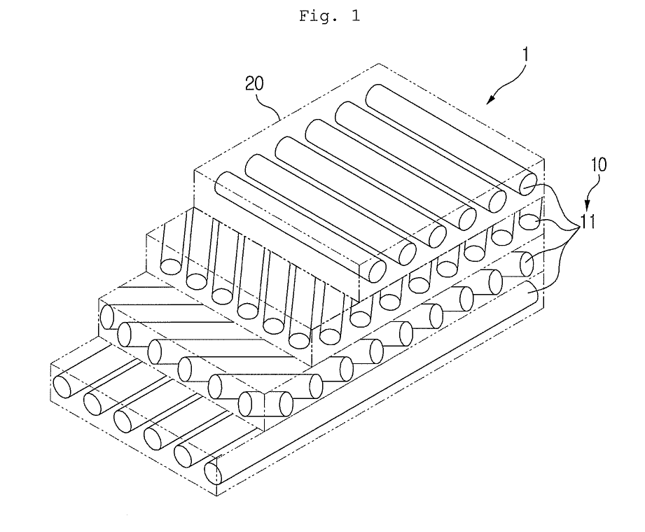

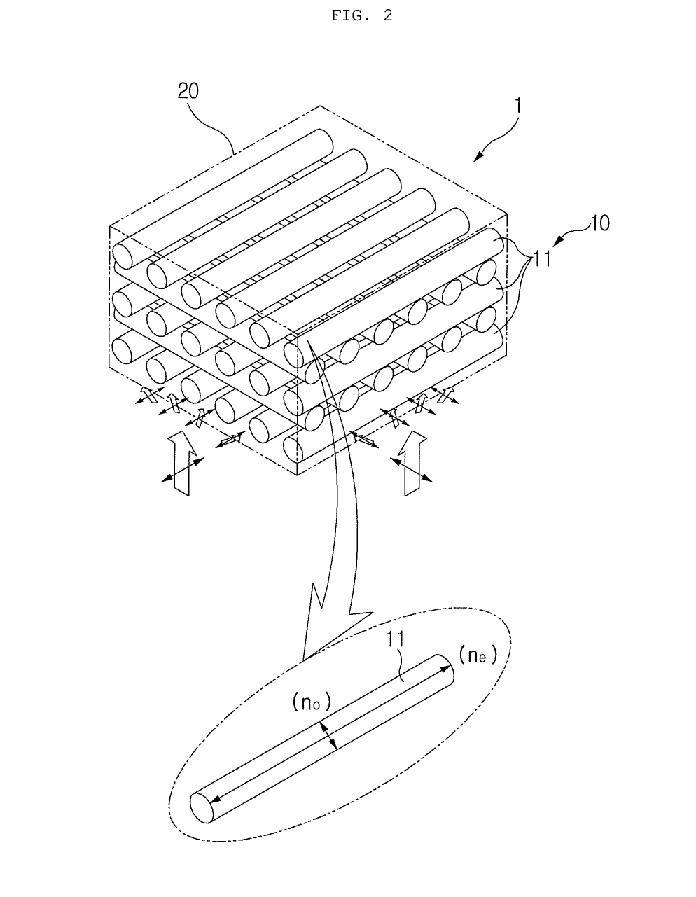

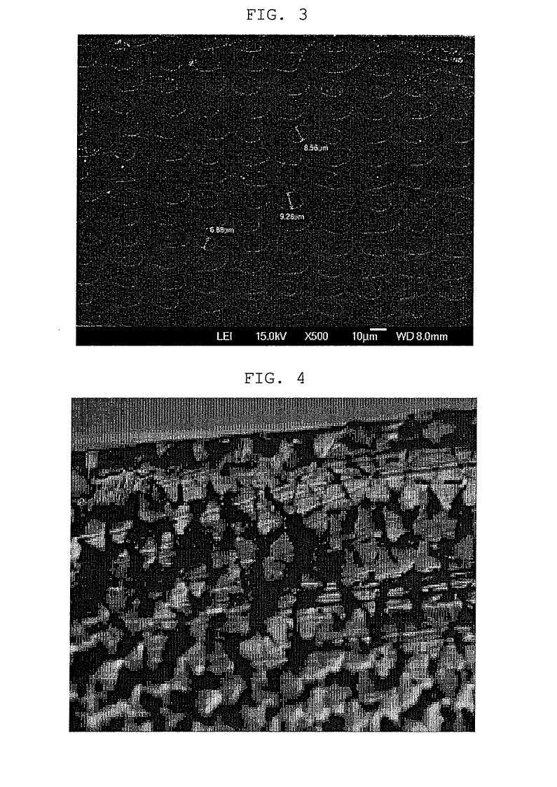

FIGS. 1 and 2 are schematic structures showing a diffusion sheet according to the preferred embodiments of the present invention, wherein at least two or more fibrous layers (10), each fibrous layer having organic fibers (11) arranged in parallel to each other in one direction, are alternately stacked at the combination of at least two or more angles of 0°, 90°, and ±θ within an optically isotropic or optically anisotropic polymer matrix (20).

In more detail, the diffusion sheet of FIG. 1 has a configuration wherein the at least two or more fibrous layers (10) are alternately stacked at the combination of 90° and ±θ with respect to each other, and the diffusion sheet of FIG. 2 shows at least two or more fibrous layers (10) having the organic fibers (11) are arranged in parallel to each other in one direction and orthogonally stacked between successive layers in the matrix (nₚ). As a result, the light source incident on the structure of the diffusion sheet is scattered two-dimensionally.

At this time, the matrix (20) used in the present invention is made of an optically isotropic or optically anisotropic polymer resin, and the organic fibers (11) constituting each fibrous layer (10) are a birefringent material having extraordinary refractive index (nₑ) of 1.650 and ordinary refractive index (nₒ) of 1.460. In this case, the refractive indexes are not limited thereto.

FIG. 3 is a photograph showing the section of the diffusion sheet according to the present invention, wherein the neighboring fibers on the fibrous layers (10) of the diffusion sheet (1) are spaced apart from each other by a constant distance in such a manner as to be arranged in parallel to each other. Further, preferably, the at least two or more fibrous layers (10) are alternately arranged at the angle of 90°, at the angle of ±θ, or at the combination of the angle of ±θ after arranged at the angle of 90°. Most preferably, the at least two or more fibrous layers (10) are alternately orthogonally stacked between successive layers (at the angle of 90°), but if the organic fibers on each fibrous layer are spaced apart from each other and the two or more fibrous layers are alternately arranged, the fibrous layers are arranged obliquely at the angle of ±θ or at the combinations of the angle of ±θ after arranged perpendicularly (at the angle of 90°).

According to the present invention, preferably, the at least two or more fibrous layers (10) of the diffusion sheet (1) are the alternately piled-up structure, and more preferably, two to five fibrous layers (10) are alternately stacked in the matrix (10). At this time, if the fibrous layers (10) are less than two layers, one-dimensional scattering occurs, and contrarily, if the fibrous layers (10) are over five layers, the loss of light is increased through the absorption and reflection of light occurring on each layer.

According to the present invention, the organic fibers (11) constituting each fibrous layer (10) of the diffusion sheet (1) are preferably made of birefringent organic fibers, and more preferably, the refractive index of the organic fibers is 0.05% greater than the refractive index of the polymer resin constituting the matrix (20). The optical transmittance of 40% or more can be achieved in accordance with the design of the refractive index.

Preferably, the organic fibers (11) of the fibrous layers (10) are one or more selected from the group consisting of polyethylene naphthalate (PEN), polycyclohexane dimethylterephthalate (PCT), co-polyethylene naphthalate (co-PEN), polyethylene therephthalate (PET), polycarbonate (PC), polycarbonate alloy, polystyrene (PS), heat-resistant polystyrene (PS), polymethyl methacrylate (PMMA), polybutylene terephthalate (PBT), polypropylene(PP), polyethylene(PE), acrylonitrile butadiene styrene (ABS), polyurethane (PU), polyimide (PI), polyvinyl chloride (PVC), styrene acrylonitrile copolymer (SAN), ethylene-vinyl acetate (EVA), polyamide (PA), polyoxymethylene(POM), phenol, epoxy(EP), urea-formaldehyde (UF), Melamine-formaldehyde (MF), unsaturated polyester (UP), silicone (SI), elastomer, and cyclo-olefin polymer (COP).

Preferably, the component of the matrix (20) is any one selected from the group consisting of poly-4-methylene pentene (PMP), polymethyl methacrylate (PMMA), polystyrene (PS), polyethylene therephthalate (PET), random copolymer resin of styrene and methyl methacrylate (MS resin), or polycarbonate (PC).

According to the present invention, polyethylene naphthalate (PEN) or polycyclohexane dimethylterephthalate (PCT) is used as the component of the organic fibers (11) of the fibrous layers (10), and poly-4-methylene pentene (PMP) or polyethylene therephthalate (PET) is used as the component of the matrix (20). Of course, the organic fibers (11) and the component of the matrix (20) are not limited thereto.

At this time, the selection and contents of the organic fibers of the fibrous layers (10) and the transparent polymer resin of the matrix (20) have influences on the optical properties of the diffusion sheet (1), and according to the present invention, if the birefringent organic fibers are made of polycyclohexane dimethylterephthalate (PCT) and the transparent polymer resin of the matrix (20) is made of poly-4-methylene pentene (PMP), haze of 85% or more and transmittance of 75% or more are satisfied when the birefringent organic fibers (11) and the component of the matrix (20) are contained at the weight ratio of 3:7 to 5:5.

According to the present invention, the diffusion sheet fabricated monolayered on which the organic fibers (11) are disposed in parallel to the matrix (20) in one direction exhibits birefringence. In more detail, if the diffusion sheet is disposed at an angle of Ψ with respect to crossed polarizers, the transmittance of the diffusion sheet exhibiting the birefringence is calculated by Expressions 1 and 2.

$$\begin{matrix}M = [ \begin{matrix}1 & 0 \\ 0 & 0\end{matrix} ] [ \begin{matrix}- {e}^{i Γ \text{/} 2} {cos}^{2} Ψ + & - i sin ( Γ \text{/} 2 ) sin ( 2 Ψ ) \\ {e}^{- i Γ \text{/} 2} {sin}^{2} Ψ & \\ - i sin ( Γ \text{/} 2 ) sin ( 2 Ψ ) & {e}^{i Γ \text{/} 2} {cos}^{2} Ψ + \\ & {e}^{- i Γ \text{/} 2} {sin}^{2} Ψ\end{matrix} ] [ \begin{matrix}0 & 0 \\ 0 & 1\end{matrix} ] & ( 1 ) \\ T = \frac{1}{2} {sin}^{2} \frac{Γ}{2} = \frac{1}{2} {sin}^{2} [ \frac{π ( {n}_{e} - {n}_{0} ) d}{λ} ] & ( 2 )\end{matrix}$$

At this time, as appreciated from Expressions 1 and 2, the transmittance is the highest when the angle of Ψ is 45°, and the transmittance is zero when the angle of Ψ is 0° or 90°. Therefore, it can be checked from the result of FIG. 3 that the birefringence is exhibited by the arrangement of the fibrous layers (10) in the polymer matrix (20) of the diffusion sheet (1).

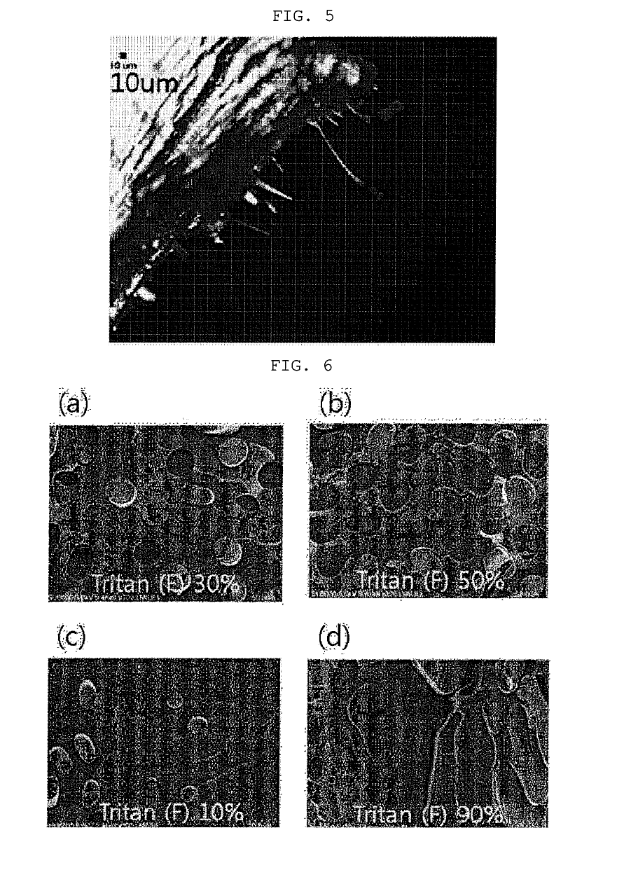

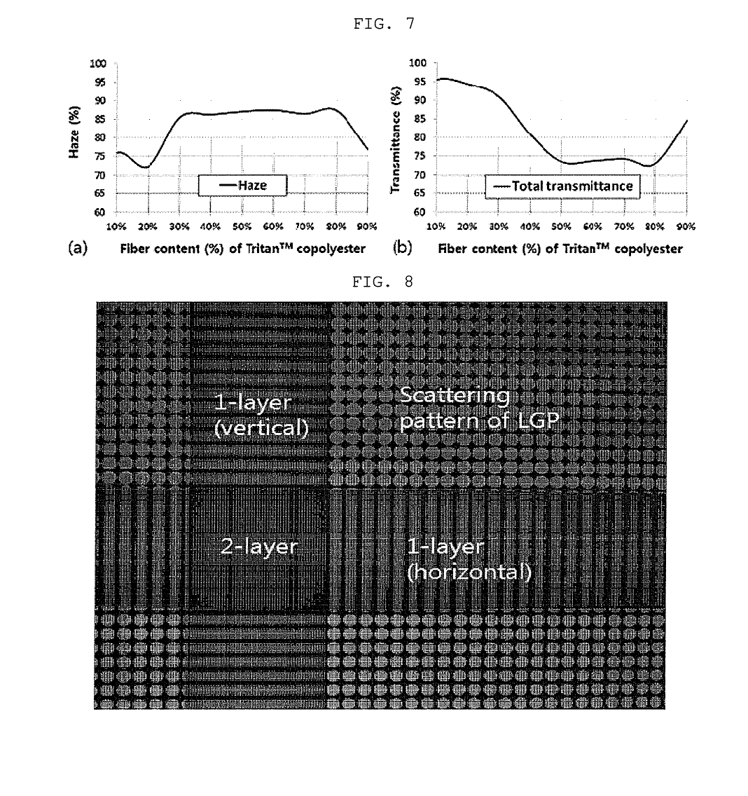

FIG. 5 is an image showing the surface of organic fibers constituting the diffusion sheet according to the present invention, FIG. 6 is an image showing the surfaces of the films through a scanning electron microscope according to the mixing ratios of the organic fibers and transparent polymer resin constituting the diffusion sheet according to the present invention, and FIG. 7 is an image showing optical properties of the diffusion sheets of FIG. 6. If the organic fibers are contained in the range of 30 to 50 weight %, spherical shapes having given sizes are generally observed on the surface, which provides effective scattering effects and satisfies excellent haze and transmittance.

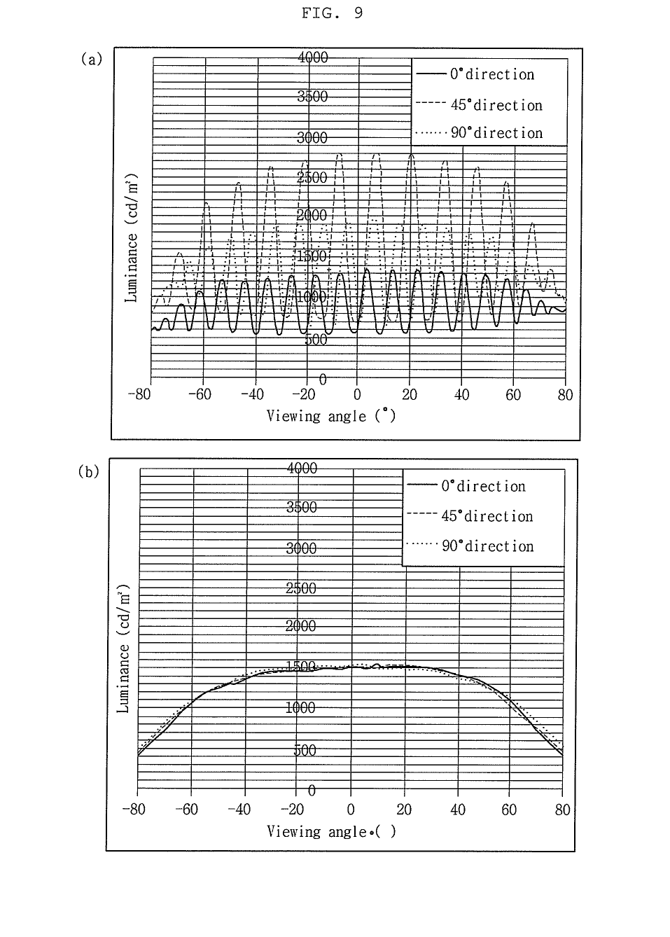

FIG. 8 is diffusion image shows the scattering patterns of the diffusion sheet according to the present invention. Dotted spots are observed on a portion where a light guide plate LGP of a backlight unit is located, and when the monolayered diffusion sheet is embedded in the matrix is disposed on the portion, the fine dotted spots are still observed, so that sufficient diffusion effects cannot be expected. Contrarily, if the diffusion sheet (1) to the present invention has the two fibrous layers alternately stacked in the matrix (20), the dotted spots are not almost observed, thus exhibiting excellent opacity.

Accordingly, the structure of the diffusion sheet (1) according to the present invention promotes two-dimensional diffusion distributions, thus uniformly diffusion performance exhibits excellent and uniform distributions, irrespective of the viewing angle and direction.

FIG. 9 is graph showing angular distributions of the luminance with respect to the angle along the horizontal angle of 0°, oblique angle of 45°, and vertical angle of 90° directions (a) without the diffusion sheet and (b) with the diffusion sheet according to the present invention.

In more detail, FIG. 9 (a) shows the measurement of only the LGP, without having any of the diffusion sheet (1) according to the present invention, wherein light distribution angles are not uniform due to the white dotted spots generated on the surface of the LGP, and contrarily, FIG. 9 (b) shows the measurement result of light distribution angles of the diffusion sheet according to the present invention, the brightness profile when light passed through the fabricated diffusion sheet via the LGP, it resulted in excellent uniform angular distributions.

Accordingly, light transmittance is improved through the one-dimensional scattering (scattering polarizing plate) relative to the selective polarization and the more transparent polymer resin combination, thus achieving uniform light diffusion, and therefore, conventional bead type diffusion sheets can be replaced with the diffusion sheet according to the present invention.

Furthermore, the sectional shapes of the organic fibers constituting the fibrous layers are a circle, but not limited to, include, a triangle, a square, or a different shaped section having a combination thereof. At this time, the fiber materials for constituting the different shaped section and the refractive indexes of the fibers may be changed.

According to the present invention, the transparent polymer resin of the matrix (20) and the organic fibers (11) of the fibrous layers (10) of the diffusion sheet (1) are the same as mentioned above, and the matrix (20) and the fibrous layers (10) are formed through the conjugated spinning of the transparent polymer resin and the organic fibers (11), so that the transparent polymer resin used may be made of a anisotropic polymer resin as well as an isotropic polymer resin.

The present invention provides a method for manufacturing a diffusion sheet.

According to a first embodiment of the present invention, there is provided a method for manufacturing a diffusion sheet including: the first step of feeding birefringent organic fiber component and a transparent component into a bi-component spinneret, the second step of extruding simultaneously the birefringent organic fibers in one direction into a polymer matrix made of a transparent polymer resin and being alternately stacked 90° and ±θ with respect to each other between successive layers of the polymer to form at least two or more fibrous layers in-situ manner, and the third step of elongating and cooling the fibrous layers arranged in the matrix.

In the first step where the transparent polymer resin and the birefringent organic fibers are injected at the same time into the bi-component spinneret, the transparent polymer resin and the birefringent organic fibers are injected preferably at the weight ratio of 7:3 to 3:7. If the injection ratio of the birefringent organic fibrous component is out of the desirable range, light scattering becomes undesirably strong.

In the first step, further, the melt of the two components is injected and simultaneously extruded into the bi-component spinneret and then spun at a spinning speed of 1 to 7 km/min, thus obtaining the nano-long fibers having a diameter of 500 nm or less. Through the high speed spinning, furthermore, filament type nano-long fibers may be made. According to the present invention, at this time, the bi-component spinneret has 3800 holes, but of course, the number of holes in fiber spinning may be increased.

In the first step, it is important to choose the materials of the matrix component and the fibrous layer component so as to simultaneously extrude the matrix component and the fibrous layer component made of the materials to be melted.

In the second step where the two to five fibrous layers are alternately stacked, preferably, when the respective layers are alternately stacked, they are orthogonally stacked between successive layers (at the angle of 90°) to the arrangement directions of the organic fibers, thus taking a form of a grid, but are limited thereto. Alternatively, they are arranged obliquely at the angle of ±θ or at the combination of the angle of ±θ after arranged orthogonally (at the angle of 90°).

Through the third step in the method for manufacturing the diffusion sheet according to the present invention, the fibrous layers can obtain desired birefringence through the elongation process. That is, the organic fibers (11) constituting each fibrous layer are made of the birefringent materials having extraordinary refractive index (nₑ) of 1.650 and ordinary refractive index (nₒ) of 1.460.

Further, the polymer matrix (20) is preferably made of an isotropic polymer resin, but may be made of an anisotropic polymer resin.

According to a second embodiment of the present invention, there is provided a method for manufacturing a diffusion sheet including: the first step of feeding birefringent organic fiber component and a transparent component into a bi-component spinneret, the second step of extruding simultaneously the birefringent organic fibers in one direction into a polymer matrix made of a transparent polymer resin and being stacked 90° and ±θ with respect to each other between successive layers of the polymer to form at least two or more fibrous layers in-situ manner; and the third step of binding alternately the fibrous layers stacked with each other.

The first step in the method according to the present invention is the process for forming the single fibrous layer, and since the matrix and the fibrous layer are the same as mentioned above, therefore, an explanation on them will be avoided for the brevity of the description.

Accordingly, the alternately piled-up structure of the diffusion sheet (1) of the present invention is configured to have the at least two or more fibrous layers (10) alternately stacked in the matrix (20), each fibrous layer (10) having the organic fibers (11) arranged in parallel to each other in one direction, so that the diffusion sheet promotes two-dimensional diffusion distributions, thus uniformly diffusing the light irrespective of the initial angle and direction.

Since the diffusion sheet 1 of the present invention obtains excellent uniform light diffusion, thus allowing the conventional bead type diffusion sheets to be replaced thereby. Further, the present invention provides a backlight unit for a liquid crystal display that is improved in optical properties, through the diffusion sheet, thus achieving excellent opacity and light diffusion.

Hereinafter, the present invention will be in detail described with reference to various embodiments.

The embodiments are suggested just to explain the present invention, but do not limit the scope of the present invention.

### Example 1

An organic fiber component of a fibrous layer, polyethylene naphthalate (PEN), was melted and pressedly spun at a spinning speed of 1 km/min through a spinning nozzle having 3800 holes, thus making organic fibers. The 3800 organic fibers and a transparent polymer resin of a matrix, poly-4-methylene pentene (PMP, TPX RT18 which is a trademark of Mitsui Chemicals) were at the same time mixed and extruded at the weight ratio of 1:9. At this time, the melting temperature of the transparent polymer resin (PMP) was 232° C. and that of the organic fiber component (PEN) was 280° C., so that a difference temperature between the melting temperatures of the two components was 48° C.

The organic fibers were arranged in parallel to each other in one direction in the polymer matrix, and the organic fibers were orthogonally stacked between successive layers, thus having two fibrous layers laminated on each other. After that, the organic fibers on the two fibrous layers were rapidly cooled and hardened by means of air blowing, and then elongated by means of high temperature and high pressure air. The organic fibers were obtained desired birefringence through the elongation process. The ordinary refractive index (nₒ) of the organic fibers was correspondence to that of the isotropic matrix (nₚ), and the extraordinary refractive index (nₑ) of the organic fibers did not correspond to that of the isotropic matrix (nₚ). At this time, the extraordinary refractive index (nₑ) of the organic fibers was 1.650, and the ordinary refractive index (nₒ) of the organic fibers was 1.460.

### Example 2

The processing for manufacturing the diffusion sheet was carried out in the same manner as in Example 1, except that the organic fibers and the transparent polymer resin (PMP, TPX RT18 which is a trademark of Mitsui Chemicals) were simultaneously mixed and extruded at the weight ratio of 4:6.

### Example 3

The processing for manufacturing the diffusion sheet was carried out in the same manner as in Example 1, except that the organic fibers and the transparent polymer resin (PMP, TPX RT18 which is a trademark of Mitsui Chemicals) were simultaneously mixed and extruded at the weight ratio of 5:5.

### Example 4

The processing for manufacturing the diffusion sheet was carried out in the same manner as in Example 1, except that an organic fiber component of a fibrous layer, polycyclohexane dimethylterephthalate copolymer (PCT, Tritan TX2001 which is a trademark of Eastman company) and a transparent polymer resin of a matrix, poly-4-methylene pentene (PMP, TPX RT18 which is a trademark of Mitsui Chemicals) were at simultaneously mixed and extruded at the weight ratio of 3:7. At this time, the melting temperature of the transparent polymer resin PCT was 250° C. and that of the organic fiber component PMP was 232° C., so that a difference temperature between the melting temperatures of the two components was 30° C.

### Example 5

The processing for manufacturing the diffusion sheet was carried out in the same manner as in Example 4, except that the organic fiber component PCT (Tritan TX2001 which is a trademark of Eastman company) and the transparent polymer resin PMP (TPX RT1.8 which is a trademark of Mitsui Chemicals) were at the same time mixed and extruded at the weight ratio of 5:5.

### Comparative Example 1

The processing for manufacturing the fabricated monolayered diffusion sheet was carried out in the same manner as in Example 1, except that the organic fibers were arranged in parallel to each other in one direction in the matrix made of the transparent polymer resin, poly-4-methylene pentene (PMP, TPX RT18 which is a trademark of Mitsui Chemicals).

### Comparative Example 2

The processing for manufacturing the diffusion sheet was carried out in the same manner as in Example 1, except that the organic fibers and the transparent polymer resin (PMP, TPX RT18 which is a trademark of Mitsui Chemicals) were simultaneously mixed and extruded at the weight ratio of 8:2.

### Comparative Example 3

The processing for manufacturing the diffusion sheet was carried out in the same manner as in Example 4, except that the organic fiber component PCT (Tritan TX200.1 which is a trademark of Eastman company) and the transparent polymer resin PMP (TPX RT18 which is a trademark of Mitsui Chemicals) were simultaneously mixed and extruded at the weight ratio of 1:9.

### Comparative Example 4

The processing for manufacturing the diffusion sheet was carried out in the same manner as in Example 4, except that the organic fiber component PCT (Tritan TX2001 which is a trademark of Eastman company) and the transparent polymer resin PMP (TPX RT1.8 which is a trademark of Mitsui Chemicals) were simultaneously mixed and extruded at the weight ratio of 9:1.

### Experiment 1

### Birefringence Measurement

The transmittance of the diffusion sheet made in the Example 1 was measured when the distance between the diffusion sheet and crossed polarizers was 45° or 0°.

As a result, when the distance was 45°, the diffusion sheet exhibited high transmittance, but contrarily, when the distance was 0°, the diffusion sheet exhibited low transmittance.

The monoolayered diffusion sheet fabricated that the nano-sized fibers were embedded within the isotropic polymer matrix corresponded to the theoretical birefringence results calculated by the following expressions 1 and 2, which indicated that the fibrous layer was well aligned.

$$\begin{matrix}M = [ \begin{matrix}1 & 0 \\ 0 & 0\end{matrix} ] [ \begin{matrix}- {e}^{i Γ \text{/} 2} {cos}^{2} Ψ + & - i sin ( Γ \text{/} 2 ) sin ( 2 Ψ ) \\ {e}^{- i Γ \text{/} 2} {sin}^{2} Ψ & \\ - i sin ( Γ \text{/} 2 ) sin ( 2 Ψ ) & {e}^{i Γ \text{/} 2} {cos}^{2} Ψ + \\ & {e}^{- i Γ \text{/} 2} {sin}^{2} Ψ\end{matrix} ] [ \begin{matrix}0 & 0 \\ 0 & 1\end{matrix} ] & ( 1 ) \\ T = \frac{1}{2} {sin}^{2} \frac{Γ}{2} = \frac{1}{2} {sin}^{2} [ \frac{π ( {n}_{e} - {n}_{0} ) d}{λ} ] & ( 2 )\end{matrix}$$

### Experiment 2

### Surface Measurement of Fibrous Layer

The measurement result of the fibrous layer used for the transmittance experiment in Experiment 1 through the scanning electron microscope is shown in FIG. 5. As a result, it was checked that the organic fibers smaller than the micro-sized fibers were seen.

FIG. 6 is an image showing the surfaces of the films through a scanning electron microscope according to the mixing ratios of the organic fibers and transparent polymer resin constituting the diffusion sheet according to the present invention, wherein the surfaces of the diffusion sheets are magnified 700 times in surface according to 30 weight % (FIG. 6 (a)), 50 weight % (FIG. 6 (b)), 10 weight % (FIG. 6 (c)), and 90 weight % (FIG. 6 (d)) of the organic fibers PCT.

As a result, if the contents of the organic fibers PCT were 30 weight % (in Example 4) and 50 weight % (in Example 5), the spherical shapes of the organic fibers having mean particle sizes of 20 μm were observed uniformly on the fibrous layer, so that the organic fibers acted as scattering beads to achieve excellent light diffusion. Contrarily, if the contents of the organic fibers were 10 weight % (in Comparative Example 3), the spherical shapes of the organic fibers having mean particle sizes of 5 μm were observed, but the organic fibers were not formed well. Further, if the contents of the organic fibers were 90 weight % (in Comparative Example 4), the elongated shapes of the organic fibers were observed, and besides, the organic fibers were bundled to each other.

FIG. 7 is an image showing optical properties of the diffusion sheets FIGS. 6 (a) to (d), wherein excellent haze and transmittance were achieved through the optimization in the mixing ratio of the organic fibers and the transparent polymer resin constituting the diffusion sheet. That is, the haze was 87.4% when the contents of the organic fibers were in the range of 30 to 60 weight %, and the haze was drastically lowered when the contents of the organic fibers were 90 weight %, which indicated that the scattering beads were not formed. Contrarily, if contents of the organic fibers were 30 weight % in the mixing ratio of the organic fibers and the transparent polymer resin constituting the diffusion sheet, the haze was 85.5% and the transmittance was 90.9%, which exhibited the best results. In this case, tensile strength was increased to achieve the improvement in the brittleness of the diffusion sheet.

### Experiment 3

### Scattering Pattern Measurement of Diffusion sheet

So as to measure the scattering pattern of the diffusion sheet made according to the Example 1, the diffusion sheet was placed on a light guide plate LGP of a backlight unit.

The measurement result is shown in FIG. 8. In more detail, if only the LGP was located, dotted spots were clearly observed, and if the single fibrous layer was arranged, the light incident parallel to the long axes of the organic fibers was scattered only through the correspondence between the refractive index (nₑ) of the organic fibers and the refractive index (nₚ) of the isotropic matrix, and the light incident vertical to the long axes of the organic fibers was transmitted through the correspondence between the refractive index (nₒ) of the organic fibers and the refractive index (nₚ) of the isotropic matrix, so that since the light was scattered only in the direction of the long axes of the organic fibers, the dotted spots were still observed.

Contrarily, the diffusion sheet made according to Example 1 showed excellent opacity so that the dotted spots were not almost observed. Accordingly, it was checked that the diffusion sheet made according to Example 1 allowed the incident light to be scattered two-dimensionally through the structure wherein the two fibrous layers were orthogonally stacked in the matrix. Thus, the scattering of light occurred only along the long axis of the fibers and not in the direction perpendicular to it. To ensure the uniform distribution of luminance, irrespective of the direction of the incident light, we employed the orthogonally four-layer piled-up structure, which promoted two-dimensional diffusion distributions from the light sources.

### Experiment 4

### Light Distribution Angle Measurement of Diffusion Sheet

So as to measure light distribution according to the existence and non-existence of the diffusion sheet made according to Example 1, the light distribution was measured using an ELDIM (EZ Contrast XL88 system) according to the directions of horizontal angle of 0°, oblique angle of 45°, and vertical angle of 90°.

The measurement results are shown in FIGS. 9 (a) and (b), wherein FIG. 9 (a) shows that only the LGP was measured, without having the diffusion sheet of the present invention, so that the light distribution was not uniform in the directions of the horizontal angle of 0°, the oblique angle of 45° and the vertical angle of 90° due to the white dotted spots generated on the surface of the LOP, and contrarily, FIG. 9 (b) shows that since the incident light was transmitted to the diffusion sheet via the LGP, the light distribution was uniform in the directions of the horizontal angle of 0°, the oblique angle of 45° and the vertical angle of 90°.

As mentioned above, the alternately piled-up structure of the diffusion sheet of the present invention is configured to have the at least two or more fibrous layers alternately stacked in the matrix, each fibrous layer having the organic fibers arranged in parallel to each other in one direction, so that the diffusion sheet promotes two-dimensional diffusion distributions, thus uniformly diffusing the light irrespective of the initial angle and direction, thus allowing the conventional bead type diffusion sheets to be replaced thereby.

Furthermore, the backlight unit for a liquid crystal display with the diffusion sheet according to the present invention provides excellent opacity and light diffusion.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A diffusion sheet configured to have at least two or more fibrous layers alternately embedded within a matrix and arranged at the combination of at least two or more angles of 0°, 90° and ±θ between successive layers, each fibrous layer having nano-sized fibers is arranged in parallel to each other in one direction.

2. The diffusion sheet according to claim 1, wherein the polymer matrix is made of an optically isotropic or optically anisotropic polymer resin.

3. The diffusion sheet according to claim 1, wherein when the nano-sized fibers of each fibrous layer are arranged in one direction, the fibers are adjacent parallel to each other at given constant intervals.

4. The diffusion sheet according to claim 1, wherein the nano-sized fibers are birefringent organic fibers.

5. The diffusion sheet according to claim 4, wherein the refractive index of the birefringent organic fibers is 0.05% greater than the refractive index of the transparent polymer resin of the polymer matrix.

6. The diffusion sheet according to claim 5, wherein under the refractive indexes, light transmittance is greater than 40%.

7. The diffusion sheet according to claim 4, wherein the sectional shapes of the birefringent organic fibers are any one selected from the group consisting of a circle, a triangle and a square, or a different shaped section having a combination thereof.

8. The diffusion sheet according to claim 5, wherein the birefringent organic fibers and the transparent polymer resin are contained at the weight ratio of 3:7 to 7:3.

9. The diffusion sheet according to claim 4, wherein the birefringent organic fibers are one or more selected from the group consisting of polyethylene naphthalate (PEN), polycyclohexane dimethylterephthalate (PCT), co-polyethylene naphthalate (co-PEN), polyethylene therephthalate (PET), polycarbonate (PC), polycarbonate alloy, polystyrene (PS), heat-resistant polystyrene (PS), polymethyl methacrylate (PMMA), polybutylene terephthalate (PBT), polypropylene(PP), polyethylene(PE), acrylonitrile butadiene styrene (ABS), polyurethane (PU), polyimide (PI), polyvinyl chloride (PVC), styrene acrylonitrile copolymer (SAN), ethylene-vinyl acetate (EVA), polyamide (PA), polyoxymethylene(POM), phenol, epoxy(EP), urea-formaldehyde (UF), Melamine-formaldehyde (MF), unsaturated polyester (UP), silicone (SI), elastomer, and cyclo-olefin polymer (COP).

10. The diffusion sheet according to claim 8, wherein when the birefringent organic fibers are polycyclohexane dimethylterephthalate (PCT) and the transparent polymer resin is poly-4-methylene pentene (PMP), the birefringent organic fibers and the transparent polymer resin are contained at the weight ratio of 3:7 to 5:5.

11. A method for manufacturing a diffusion sheet, the method comprising the steps of:
feeding birefringent organic fiber component and a transparent component into a bi-component spinneret,
extruding simultaneously the birefringent organic fibers in one direction into a polymer matrix made of a transparent polymer resin and being alternately stacked 90° and ±θ with respect to each other between successive layers of the polymer to form at least two or more fibrous layers in-situ manner, and
elongating and cooling the fibrous layers arranged in the matrix.

12. A method for manufacturing a diffusion sheet, the method comprising the steps of:
feeding birefringent organic fiber component and a transparent component into a bi-component spinneret,
extruding simultaneously the birefringent organic fibers in one direction into a polymer matrix made of a transparent polymer resin and being stacked 90° and ±θ with respect to each other between successive layers of the polymer to form at least two or more fibrous layers in-situ manner, and
binding alternately the fibrous layers stacked with each other.

13. The method according to claim 11, wherein the birefringent organic fibers and the transparent polymer resin are extruded simultaneously at the weight ratio of 3:7 to 7:3.

14. The method according to claim 12, wherein the binding is any one selected from the group consisting of double belt press, lamination and calendaring.

15. A backlight unit for a liquid crystal display equipped with the diffusion sheet according to claim 1.

16. The method according to claim 12, wherein the birefringent organic fibers and the transparent polymer resin are extruded simultaneously at the weight ratio of 3:7 to 7:3.
